(19) United States
(12) Patent Application Publication
(10) Pub. No.: US 2015/0345132 A1
(43) Pub. Date: Dec. 3, 2015

(54) FIBER REINFORCEMENT FIRE-PROOF THERMAL INSULATION PLATE AND PREPARATION PROCESS THEREOF

(71) Applicant: GUANG ZHOU ZONG BAO XIAN WEI ZHI PIN CO., LTD., Guangzhou (CN)

(72) Inventor: ZHIPING HUANG, Guangzhou (CN)

(21) Appl. No.: 14/326,314

(22) Filed: Jul. 8, 2014

(30) Foreign Application Priority Data
May 30, 2014 (CN) 201410235375.6

(51) Int. Cl. E04B 1/80; B29C 70/54; B29C 35/04; B29B 15/08

(52) U.S. Cl. CPC E04B 1/80; B29B 15/08; B29C 70/545; B29C 35/049; B29K 2105/0026

(57) ABSTRACT

The present invention discloses a fiber reinforcement fire-proof thermal insulation plate, which is prepared by raw materials having the following weight portions: 80-100 portions of fly ash, 30-50 portions of expanded perlite, 10-20 portions of haydite, 10-20 portions of vegetable fiber, 5-10 portions of winnowing beads, 5-8 portions of sepiolite, 3-5 portions of sodium fluorosilicate, 3-5 portions of calcium formate, 3-5 portions of flame-retardant, 0.1-0.5 portion of triisopropanolamine loeate and 0.1-0.3 portion of dimethoxy-ethane. According to the present invention, industrial production wastes are adopted as main raw materials, so that the production cost is reduced; and defects in the existing building thermal insulation plates can be effectively overcome through the cooperation effect produced by organic combination of the fly ash, light aggregates and additives.

### CROSS REFERENCE TO THE RELATED PATENT APPLICATION

The present application claims the priority of the Chinese patent application CN 201410235375.6 filed on May 30, 2014.

### FIELD OF THE INVENTION

The present invention belongs to the technical field of building thermal insulation materials, and in particular, to a fiber reinforcement fire-proof thermal insulation plate and preparation process thereof.

### BACKGROUND OF THE INVENTION

In the field of thermal insulation materials, a fire-proof thermal insulation plate is a kind of structural material that is developed in recent years. However, the existing preparation process and preparation ratio cannot adapt to the requirements of the building industry on energy saving and environment protection as well as the increasingly developed requirements on the property of the material itself apparently. Moreover, the existing preparation process has poor fire-proof performance and low intensity. At present, the fiber reinforcement fire-proof plates more widely applied on the market are plates that are prepared by adopting lower vegetable fibers mixed with such in-organics as glue or resin and gypsum, and magnesium or cement for stirring, and finally pressurizing to make plates. However, the foregoing vegetable fiber plates will creep water and deform after sucking water for a long time, and cause shape dismantling; moreover, the fire retardancy, the weather resisting property, the corrosion resistance and the yield thereof will be influenced certainly, which cannot meet the demands of actual markets, and thus cannot be widely accepted by the market.

Thus it can be seen that the present fiber reinforcement fire-proof thermal insulation plate still has multiple defects, and cannot meet the increasingly developed market requirements. Therefore, an excellent solution is urgently needed.

### SUMMARY OF THE INVENTION

The present invention aims at providing a fiber reinforcement fire-proof thermal insulation plate and preparation process thereof. According to the preparation process of the present invention, wastes are mainly used as main raw materials, so that the cost of the thermal insulation plate is greatly reduced; moreover, the preparation process has simple steps, and meets the requirements of energy saving and environment protection; the fiber reinforcement fire-proof thermal insulation plate obtained not only has excellent fire-proof thermal insulation performances, but also has such effects as sound insulation, high intensity, acid-base resistance, corrosion resistance, no deformation, shaking resistance, pressing resistance and light weight, and the like.

In order to realize the foregoing objectives, the present invention adopts a technical solution as follows.

A fiber reinforcement fire-proof thermal insulation plate is prepared by raw materials having the following weight portions:

80-100 portions of fly ash, 30-50 portions of expanded perlite, 10-20 portions of haydite, 10-20 portions of vegetable fiber, 5-10 portions of winnowing beads, 5-8 portions of sepiolite, 3-5 portions of sodium fluorosilicate, 3-5 portions of calcium formate, 3-5 portions of flame-retardant, 0.1-0.5 portion of triisopropanolamine loeate and 0.1-0.3 portion of dimethoxy-ethane. Preferably,

The fly ash is grade I or grade II fly ash produced by a power station;

The haydite has a bulk density of 450 kg/cm3;

the vegetable fiber can be one or a mixture of two of wood fiber, hemp palm fiber, coconut fiber, cotton stalk fiber, bamboo fiber and nut shell fiber;

The winnowing beads are light particle material winnowed from fly ash and filtered by a 80-100 mesh screen;

The flame-retardant is mainly prepared by raw materials having the following weight portions: 100 portions of sodium tripolyphosphate, 70 portions of phosphorus pentoxide, 60 portions of diethanolamine, 50 portions of sodium carbonate, 20 portions of sodium hydroxide and 40 portions of ethanol.

A preparation process of fiber reinforcement fire-proof thermal insulation plate comprises the following process steps:

(1) preparation:

a) removing impurity part of the vegetable fiber raw materials, cutting the vegetable fiber raw materials into 20 cm-30 cm small segments, adopting an air flow type drying machine or a roller type drying machine to dry the vegetable fiber raw materials till moisture of the vegetable fiber raw materials is below 0.1%, and then cutting the vegetable fiber raw materials into 3-5 cm for reserve;

b) putting the fly ash, expanded perlite, haydite and sepiolite into a pulverizer for pulverization, and then filtering through a 80-100 mesh for reserve;

(2) Mixing: putting the fly ash, expanded perlite, haydite, winnowing beads and sepiolite into a stirrer according to the foregoing weight portion proportion firstly, stirring for 5-10 minutes so that the materials are uniformly mixed, then adding the vegetable fiber, sodium fluorosilicate, calcium formate, flame-retardant, triisopropanolamine loeate and dimethoxy-ethane in sequence and stirring for 3-5 minutes, after the materials are uniformly mixed, adding proper water to stir for 10-15 minutes, thus obtaining a mixed sizing agent;

(3) Initial set: injecting the mixed sizing agent into a mold, standing and solidifying for 20-50 minutes, thus forming a shaping material;

(4) Shaping: putting the obtained shaping material into a mold for hot pressing and shaping, thus obtaining a plate blank;

(5) Steam-curing: putting the prepared plate blank into a steam-curing chamber, and injecting steams for steam-curing, thus obtaining a plank;

(6) Cutting: cutting the plank after steam-curing according to a size required, thus obtaining a finished product of the fiber reinforcement fire-proof thermal insulation plate of the present invention.

During shaping in step (4), a shaping temperature is 160° C.-180° C., a shaping pressure is 2 MPa-3 MPa, and a shaping time is 5-10 min.

During steam-curing in step (5), a steam-curing time is 10-12 h, and an indoor steam-curing temperature is kept at 100-170° C.

In the fiber reinforcement fire-proof thermal insulation plate prepared by the present invention, the fly ash and the winnowing beads adopted are wastes produced during industrial production, and the production cost is greatly reduced when the fly ash and the winnowing beads are adopted as base materials. All the expanded perlite, the haydite and the sepiolite are particles having light weight and regular shape, which can sufficiently fill in gaps when being used as aggregates and filled into the thermal insulation plate, greatly improve the thermal insulation performance of the thermal insulation plate, and also largely reduce the specific density of the thermal insulation plate. The vegetable fibers are distributed in the thermal insulation plate disorderly, which not only can avoid cracks, but also can stop crack from spreading, and also greatly improve the intensity of the thermal insulation plate. The flame-retardant fire-proof components in the flame-retardant do not volatilize and run off, which can greatly improve the fire-proof thermal insulation performance of the thermal insulation plate.

The present invention has the advantageous effects that:

1. According to the present invention, industrial production wastes are adopted as main raw materials, so that the production cost is reduced; and defects in the existing building thermal insulation plates can be effectively overcome through the cooperation effect produced by organic combination of the fly ash, light aggregates and additives, and a composite thermal insulation layer is not needed when in use, and fire prevention and crack resistance can be effectively achieved meanwhile.

2. The fiber reinforcement fire-proof thermal insulation plate obtained by the present invention not only has excellent fire-proof thermal insulation performances, but also has such effects as sound insulation, high intensity, acid-base resistance, corrosion resistance, no deformation, shaking resistance, pressing resistance and light weight, and the like.

3. The fiber reinforcement fire-proof thermal insulation plate obtained by the present invention can be widely applied to build interior and exterior walls, is convenient to use and construct, can complete architectural construction, thermal insulation and fire-proof procedures at a time, and omits a composite wall surface thermal insulation procedure. Meanwhile, the plate is easy to process, can be sawn, drilled, nailed, hung, hollowed, and the like, which brings great convenience for pipeline burying and installing as well as secondary decoration.

### DETAILED DESCRIPTION OF THE EMBODIMENTS

A fiber reinforcement fire-proof thermal insulation plate of the present invention is prepared by raw materials having the following weight portions:

80-100 portions of fly ash, 30-50 portions of expanded perlite, 10-20 portions of haydite, 10-20 portions of vegetable fiber, 5-10 portions of winnowing beads, 5-8 portions of sepiolite, 3-5 portions of sodium fluorosilicate, 3-5 portions of calcium formate, 3-5 portions of flame-retardant, 0.1-0.5 portion of triisopropanolamine loeate and 0.1-0.3 portion of dimethoxy-ethane. Preferably,

The fly ash is grade I or grade II fly ash produced by a power station;

The haydite has a bulk density of 450 kg/cm3;

The vegetable fiber can be one or a mixture of two of wood fiber, hemp palm fiber, coconut fiber, cotton stalk fiber, bamboo fiber and nut shell fiber;

The winnowing beads are light particle material winnowed from fly ash and filtered by a 80-100 mesh screen;

The flame-retardant is mainly prepared by raw materials having the following weight portions: 100 portions of sodium tripolyphosphate, 70 portions of phosphorus pentoxide, 60 portions of diethanolamine, 50 portions of sodium carbonate, 20 portions of sodium hydroxide and 40 portions of ethanol. The fiber reinforcement fire-proof thermal insulation plate is specifically prepared through the following process: adding 40 portions of ethanol, 60 portions of diethanolamine, 20 portions of sodium hydroxide and 50 portions of sodium carbonate in a reaction kettle equipped with a stirring device, a reflux device and a temperature controlling instrument, reacting for 8 h under 65° C., cooling the reaction mixture in the reaction kettle to a temperature below 100° C., adding 70 portions of phosphorus pentoxide and 100 portions of sodium tripolyphosphate, performing a thermal insulation for 6 h at a temperature of 100° C., then cooling the temperature below 60° C., thus obtaining a flame-retardant having high flame retardancy;

The preparation process of the fiber reinforcement fire-proof thermal insulation plate comprises the following process steps:

(1) Preparation:

a) Removing impurity part of the vegetable fiber raw materials, cutting the vegetable fiber raw materials into 20 cm-30 cm small segments, adopting an air flow type drying machine or a roller type drying machine to dry the vegetable fiber raw materials till moisture of the vegetable fiber raw materials is below 0.1%, and then cutting the vegetable fiber raw materials into 3-5 cm for reserve;

b) Putting the fly ash, expanded perlite, haydite and sepiolite into a pulverizer for pulverization, and then filtering through a 80-100 mesh for reserve;

(2) Mixing: putting the fly ash, expanded perlite, haydite, winnowing beads and sepiolite into a stirrer according to the foregoing weight portion proportion firstly, stirring for 5-10 minutes so that the materials are uniformly mixed, then adding the vegetable fiber, sodium fluorosilicate, calcium formate, flame-retardant, triisopropanolamine loeate and dimethoxy-ethane in sequence and stirring for 3-5 minutes, after the materials are uniformly mixed, adding proper water to stir for 10-15 minutes, thus obtaining a mixed sizing agent;

(3) Initial set: injecting the mixed sizing agent into a mold, standing and solidifying for 20-50 minutes, thus forming a shaping material;

(4) Shaping: putting the obtained shaping material into a mold for hot pressing and shaping, thus obtaining a plate blank;

(5) Steam-curing: putting the prepared plate blank into a steam-curing chamber, and injecting steams for steam-curing, thus obtaining a plank;

(6) Cutting: cutting the plank after steam-curing according to a size required, thus obtaining a finished product of the fiber reinforcement fire-proof thermal insulation plate of the present invention.

During shaping in step (4), a shaping temperature is 160° C.-180° C., a shaping pressure is 2 MPa-3 MPa, and a shaping time is 5-10 min.

During steam-curing in step (5), a steam-curing time is 10-12 h, and an indoor steam-curing temperature is kept at 100-170° C.

### Embodiment 1

A preparation process of fiber reinforcement fire-proof thermal insulation plate comprises the following process steps:

weighing the raw materials according to the following weight portion proportion: 80 kg fly ash, 30 kg expanded perlite, 10 kg haydite, 10 kg vegetable fiber, 5 kg winnowing beads, 5 kg sepiolite, 3 kg sodium fluorosilicate, 3 kg calcium formate, 3 kg flame-retardant, 0.1 kg triisopropanolamine loeate and 0.1 kg dimethoxy-ethane;

a) removing impurity part of the vegetable fiber raw materials, cutting the vegetable fiber raw materials into 20 cm small segments, adopting an air flow type drying machine to dry the vegetable fiber raw materials till moisture of the vegetable fiber raw materials is below 0.1%, and then cutting the vegetable fiber raw materials into 3 cm for reserve;

b) putting the fly ash, expanded perlite, haydite and sepiolite into a pulverizer for pulverization, and then filtering through a 100 mesh for reserve;

(2) Mixing: putting the fly ash, expanded perlite, haydite, winnowing beads and sepiolite into a stirrer according to the foregoing weight portion proportion firstly, stirring for 5 minutes so that the materials are uniformly mixed, then adding the vegetable fiber, sodium fluorosilicate, calcium formate, flame-retardant, triisopropanolamine loeate and dimethoxy-ethane in sequence and stirring for 3 minutes, after the materials are uniformly mixed, adding proper water to stir for 10 minutes, thus obtaining a mixed sizing agent;

(3) Initial set: injecting the mixed sizing agent into a mold, standing and solidifying for 20 minutes, thus forming a shaping material;

(4) Shaping: putting the obtained shaping material into a mold for hot pressing and shaping, thus obtaining a plate blank, wherein a shaping temperature is 160° C., a shaping pressure is 2 MPa, and a shaping time is 5 min;

(5) Steam-curing: putting the prepared plate blank into a steam-curing chamber, and injecting steams for steam-curing, thus obtaining a plank, wherein a steam-curing time is 10 h, and an indoor steam-curing temperature is kept at 100° C.

(6) Cutting: cutting the plank after steam-curing according to a size required, thus obtaining a finished product of the fiber reinforcement fire-proof thermal insulation plate of the present invention.

### Embodiment 2

A preparation process of fiber reinforcement fire-proof thermal insulation plate comprises the following process steps:

weighing the raw materials according to the following weight portion proportion: 100 kg fly ash, 50 kg expanded perlite, 20 kg haydite, 20 kg vegetable fiber, 10 kg winnowing beads, 8 kg sepiolite, 5 kg sodium fluorosilicate, 5 kg calcium formate, 5 kg flame-retardant, 0.5 kg triisopropanolamine loeate and 0.3 kg dimethoxy-ethane;

a) Removing impurity part of the vegetable fiber raw materials, cutting the vegetable fiber raw materials into 30 cm small segments, adopting an air flow type drying machine to dry the vegetable fiber raw materials till moisture of the vegetable fiber raw materials is below 0.1%, and then cutting the vegetable fiber raw materials into 5 cm for reserve;

b) Putting the fly ash, expanded perlite, haydite and sepiolite into a pulverizer for pulverization, and then filtering through a 80 mesh for reserve;

(2) Mixing: putting the fly ash, expanded perlite, haydite, winnowing beads and sepiolite into a stirrer according to the foregoing weight portion proportion firstly, stirring for 10 minutes so that the materials are uniformly mixed, then adding the vegetable fiber, sodium fluorosilicate, calcium formate, flame-retardant, triisopropanolamine loeate and dimethoxy-ethane in sequence and stirring for 5 minutes, after the materials are uniformly mixed, adding proper water to stir for 15 minutes, thus obtaining a mixed sizing agent;

(3) Initial set: injecting the mixed sizing agent into a mold, standing and solidifying for 50 minutes, thus forming a shaping material;

(4) Shaping: putting the obtained shaping material into a mold for hot pressing and shaping, thus obtaining a plate blank, wherein a shaping temperature is 180° C., a shaping pressure is 3 MPa, and a shaping time is 10 min;

(5) Steam-curing: putting the prepared plate blank into a steam-curing chamber, and injecting steams for steam-curing, thus obtaining a plank, wherein a steam-curing time is 12 h, and an indoor steam-curing temperature is kept at 170° C.

(6) Cutting: cutting the plank after steam-curing according to a size required, thus obtaining a finished product of the fiber reinforcement fire-proof thermal insulation plate of the present invention.

### Embodiment 3

A preparation process of fiber reinforcement fire-proof thermal insulation plate comprises the following process steps:

Weighing the raw materials according to the following weight portion proportion: 90 kg fly ash, 40 kg expanded perlite, 15 kg haydite, 15 kg vegetable fiber, 8 kg winnowing beads, 8 kg sepiolite, 4 kg sodium fluorosilicate, 4 kg calcium formate, 4 kg flame-retardant, 0.3 kg triisopropanolamine loeate and 0.2 kg dimethoxy-ethane;

a) Removing impurity part of the vegetable fiber raw materials, cutting the vegetable fiber raw materials into 25 cm small segments, adopting an air flow type drying machine to dry the vegetable fiber raw materials till moisture of the vegetable fiber raw materials is below 0.1%, and then cutting the vegetable fiber raw materials into 4 cm for reserve;

b) Putting the fly ash, expanded perlite, haydite and sepiolite into a pulverizer for pulverization, and then filtering through a 90 mesh for reserve;

(2) Mixing: putting the fly ash, expanded perlite, haydite, winnowing beads and sepiolite into a stirrer according to the foregoing weight portion proportion firstly, stirring for 8 minutes so that the materials are uniformly mixed, then adding the vegetable fiber, sodium fluorosilicate, calcium formate, flame-retardant, triisopropanolamine loeate and dimethoxy-ethane in sequence and stirring for 4 minutes, after the materials are uniformly mixed, adding proper water to stir for 12 minutes, thus obtaining a mixed sizing agent;

(3) Initial set: injecting the mixed sizing agent into a mold, standing and solidifying for 30 minutes, thus forming a shaping material;

(4) Shaping: putting the obtained shaping material into a mold for hot pressing and shaping, thus obtaining a plate blank, wherein a shaping temperature is 170° C., a shaping pressure is 2.5 MPa, and a shaping time is 7 min;

(5) Steam-curing: putting the prepared plate blank into a steam-curing chamber, and injecting steams for steam-curing, thus obtaining a plank, wherein a steam-curing time is 11 h, and an indoor steam-curing temperature is kept at 150° C.;

(6) Cutting: cutting the plank after steam-curing according to a size required, thus obtaining a finished product of the fiber reinforcement fire-proof thermal insulation plate of the present invention.

The foregoing is merely preferred embodiments of the present invention, but is not intended to limit the right scope of the present invention. It should be pointed out that any modification or equivalent replacement on the technical solution of the present invention made by a person having ordinary skill in the art shall not depart from the protection scope of the present invention.

What is claimed is:

1. A fiber reinforcement fire-proof thermal insulation plate, prepared by raw materials having the following weight portions:
80-100 portions of fly ash, 30-50 portions of expanded perlite, 10-20 portions of haydite, 10-20 portions of vegetable fiber, 5-10 portions of winnowing beads, 5-8 portions of sepiolite, 3-5 portions of sodium fluorosilicate, 3-5 portions of calcium formate, 3-5 portions of flame-retardant, 0.1-0.5 portion of triisopropanolamine loeate and 0.1-0.3 portion of dimethoxy-ethane;
The flame-retardant is mainly prepared by raw materials having the following weight portions: 100 portions of sodium tripolyphosphate, 70 portions of phosphorus pentoxide, 60 portions of diethanolamine, 50 portions of sodium carbonate, 20 portions of sodium hydroxide and 40 portions of ethanol.

2. The fiber reinforcement fire-proof thermal insulation plate according to claim 1, wherein the fly ash is grade I or grade II fly ash produced by a power station.

3. The fiber reinforcement fire-proof thermal insulation plate according to claim 1, wherein the haydite has a bulk density of 450 kg/cm3.

4. The fiber reinforcement fire-proof thermal insulation plate according to claim 1, wherein the vegetable fiber can be one or a mixture of two of wood fiber, hemp palm fiber, coconut fiber, cotton stalk fiber, bamboo fiber and nut shell fiber.

5. The fiber reinforcement fire-proof thermal insulation plate according to claim 1, wherein the winnowing beads are light particle materials winnowed from fly ash and filtered by a 80-100 mesh screen.

6. A preparation process of the fiber reinforcement fire-proof thermal insulation plate according to claims 1, comprising the following process steps:
(1) Preparation:
b) removing impurity part of the vegetable fiber raw materials, cutting the vegetable fiber raw materials into 20 cm-30 cm small segments, adopting an air flow type drying machine or a roller type drying machine to dry the vegetable fiber raw materials till moisture of the vegetable fiber raw materials is below 0.1%, and then cutting the vegetable fiber raw materials into 3-5 cm for reserve;
c) putting the fly ash, expanded perlite, haydite and sepiolite into a pulverizer for pulverization, and then filtering through a 80-100 mesh for reserve;
(2) mixing: putting the fly ash, expanded perlite, haydite, winnowing beads and sepiolite into a stirrer according to a weight portion proportion firstly, stirring for 5-10 minutes so that the materials are uniformly mixed, then adding the vegetable fiber, sodium fluorosilicate, calcium formate, flame-retardant, triisopropanolamine loeate and dimethoxy-ethane in sequence and stirring for 3-5 minutes, after the materials are uniformly mixed, adding proper water to stir for 10-15 minutes, thus obtaining a mixed sizing agent;
(3) Initial set: injecting the mixed sizing agent into a mold, standing and solidifying for 20-50 minutes, thus forming a shaping material;
(4) Shaping: putting the obtained shaping material into a mold for hot pressing and shaping, thus obtaining a plate blank;
(5) Steam-curing: putting the prepared plate blank into a steam-curing chamber, and injecting steams for steam-curing, thus obtaining a plank; and
(6) Cutting: cutting the plank after steam-curing according to a size required, thus obtaining a finished product of the fiber reinforcement fire-proof thermal insulation plate of the present invention.

7. The preparation process of the fiber reinforcement fire-proof thermal insulation plate according to claim 6, wherein during shaping in step (4), a shaping temperature is 160° C.-180° C., a shaping pressure is 2 MPa-3 MPa, and a shaping time is 5-10 min.

8. The preparation process of the fiber reinforcement fire-proof thermal insulation plate according to claim 6, wherein during steam-curing in step (5), a steam-curing time is 10-12 h and an indoor steam-curing temperature is kept at 100-170° C.
